(19) United States
(12) Patent Application Publication
(10) Pub. No.: US 2024/0098508 A1
(43) Pub. Date: Mar. 21, 2024

(54) COMMUNICATION SYSTEM WITH UNINTERRUPTED SERVICE IN CITIZENS BROADBAND RADIO SERVICE BAND

(71) Applicant: ARRIS Enterprises LLC, Suwanee, GA (US)

(72) Inventor: Rajesh Kaliaperumal, San Jose, CA (US)

(73) Assignee: ARRIS Enterprises LLC, Suwanee, GA (US)

(21) Appl. No.: 18/469,305

(22) Filed: Sep. 18, 2023

Related U.S. Application Data
(60) Provisional application No. 63/376,403, filed on Sep. 20, 2022.

(51) Int. Cl. H04W 16/14; H04W 72/0453

(52) U.S. Cl. CPC H04W 16/14; H04W 72/0453; H04W 84/04

(57) ABSTRACT

A communication system with uninterrupted service in citizens broadband radio service (CBRS) band is provided. The communication system includes a first base station that is in communication with at least one core network of a wireless communication service provider. The first base station is further in communication with a spectrum access system (SAS) that allocates communication channels in the CBRS band. The first base station uses the CBRS band to communicate with user equipment (UE) over a first CBRS band communication channel. A channel moving function is configured to redirect communications from the first CBRS band communication channel when a termination of grant to the first CBRS communication channel is issued by the SAS to a second communication channel provided by a second base station that provides a service coverage area for the UE through at least a second RP before the first CBRS communication channel is terminated.

### CROSS-REFERENCE TO RELATED APPLICATIONS

This application claims priority to U.S. Provisional Application Ser. No. 63/376,403, same title herewith, filed on Sep. 20, 2022, which is incorporated in its entirety herein by reference.

### BACKGROUND

As the demand for wireless communication services increase, wireless telecommunication service providers are looking to extend capacity and coverage. However, the frequency spectrum available for wireless communication is limited. One way to expand the spectrum available is to use the Citizens Broadband Radio Service (CBRS) band.

The CBRS band is a 150 MHz spectrum in the 3.5 GHz band that the Federal Communication Commission has designated for sharing among three tiers of users. The three tiers include incumbent users, priority licensees, and generally authorized. The incumbent users have historically held exclusive rights to the CBRS band. Examples of incumbent users include satellite ground stations and the United States Navy. Priority licensees purchase licenses to use communication channels within the CBRS band. A grant of the use of communication channels within the CBRS band by priority licensees is allowed provided the use does not interfere with the use of the communication channels by an incumbent user. Finally, the generally authorized users may be granted access to the communication channels within the CBRS band as long as their use does not interfere with the use by the incumbent users or priority licensees.

Wireless telecommunication service providers may use the CBRS band in providing communication links to user equipment (UEs). A private radio access network implemented in part by a base station may include one or more Citizens Broadband Radio Service Devices (CBSDs) (also referred to here as “CBRS access points (APs)”). The network is configured to use the CBRS band and one or more wireless access protocols (such as 4G LTE and 5G NR) to provide wireless connectivity to one or more of the wireless UEs that are within a service coverage area provided by one or more base stations.

A spectrum access system (SAS) is used to allocate CBRS band communication channels used by the base station to communicate with the UEs. A base station that wants to use a communication channel in the CBRS band puts in a request to the SAS, which may be cloud based, to reserve an unused channel in the 150 Mhz spectrum in a particular geographic area. If the communication channel is available, the SAS may grant the request. Once a base station is done with the CBRS band communication channel, the communication channel is put back into a pool of CBRS band communication channels that the SAS can draw from to grant further requests.

Situations arise where it is necessary for the SAS to suspend/terminate a grant to a communication channel in the CBRS band before the base station is done with communications. This may occur because an incumbent user or priority user requests to use of the communication channel. Other situations where a SAS may terminate a grant to a communication channel in the CBRS band is where, within the 150 MHz spectrum, there is contiguous channel deployments which may lead to interference. When the SAS needs to terminate a grant to a communication channel it may redirect base station to another communication channel in the CBRS band if available.

Typically, a base station has about 60 seconds to stop transmissions over the communication channel after the grant is terminated by the SAS. As a result of the termination of the grant, the termination of transmitting at the terminated communication channel by the CB SD access point of the base station will briefly cause the communication network serviced by the base station to go down. This, at least temporarily, interrupts communications to the UE that is communicating through the terminated communication channel.

For the reasons stated above and for other reasons stated below which will become apparent to those skilled in the art upon reading and understanding the present specification, there is a need in the art for a system to seamlessly switch CBRS band communication channels without communications to a UE being interrupted.

### SUMMARY OF INVENTION

The following summary is made by way of example and not by way of limitation. It is merely provided to aid the reader in understanding some of the aspects of the subject matter described. Embodiments provide a communication system with uninterrupted service in a CBRS band that switches communications from a grant terminated CBRS band communication channel that provides a communication link between a base station and a UE through a first radio point to another communication channel that provides a communication link between the base station and the UE through another radio point.

In one embodiment, a communication system with uninterrupted service in citizens broadband radio service (CBRS) band is provided. The communication system includes a first base station and a channel moving function. The first base station is in communication with at least one core network of a wireless communication service provider. The first base station is further in communication with a spectrum access system (SAS) that allocates communication channels in the CBRS band. The first base station uses the CBRS band to communicate with user equipment (UE). The first base station also includes at least one radio point (RP) to transmit and receive wireless communication signals. The first base station provides a first service coverage area for the UE that establishes a communication link with the UE using a first CBRS band communication channel. The channel moving function is configured to redirect communications from the first CBRS band communication channel when a termination of grant to the first CBRS communication channel is issued by the SAS to a second communication channel serviced by a second base station that provides a second service coverage area for the UE through at least a second RP before the first CBRS communication channel is terminated.

In another embodiment, a communication system with uninterrupted service in citizens broadband radio service (CBRS) band is provided. The communication system includes at least one base station and a channel moving function. The at least one base station is in communication with at least one core network of a wireless communication service provider. The at least one base station is in communication with a spectrum access system (SAS) that allocates communication channels in the CBRS band. The at least one base station uses the CBRS band to communicate with user equipment (UE). The at least one base station includes at least a first radio point (RP) and a second RP to transmit and receive wireless communication signals through a first and second cell. The at least one base station provides a service coverage area for the UE with the first RP to establishes a communication link with the UE using a first CBRS band communication channel in the first cell. The channel moving function is configured to redirect communications from the first CBRS band communication channel when a termination of grant to the first CBRS communication channel is issued by the SAS to a second communication channel serviced by the second RP of the second cell that provides a second service coverage area for the UE before the first CBRS communication channel is terminated.

In another embodiment, a method of operating a communication system using a citizens broadband radio service (CBRS) band is provided. The method includes using a first CBRS band communication channel provided by a first base station for communications with user equipment (UE) within a first service coverage area of the first base station; and upon receiving a notice of termination of the first CBRS band communication channel, switching communications from the first CBRS band communication channel to a second communication channel provided by one of a second base station and a cell of the first base station before the first CBRS band communication channel is terminated.

In yet another embodiment, another method of operating a communication system using a citizens broadband radio service (CBRS) band is provided. The method includes using a CBRS band communication channel for communications with a first base station and user equipment (UE) through a CBRS access point of the first base station; and upon receiving a notice of termination of the CBRS band communication channel, switching communications from the CBRS band communication channel to a non-CBRS band communication channel provided by one of a second base station and a cell before the CBRS band communication channel is terminated, wherein the UE is within a service coverage area of the one of the second base station and the cell.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a communication system with uninterrupted service in CBRS band according to one exemplary embodiment.

FIG. 2 is a block diagram of another communication system with uninterrupted service in CBRS band according to one exemplary embodiment.

FIG. 3A is a flow diagram of a method of CBRS band communication channel switching according to one exemplary embodiment.

FIG. 3B is a flow diagram of another method of CBRS band communication channel switching according to one exemplary embodiment.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a communication system with uninterrupted service in a CBRS band when communications are moved from a CBRS band communication channel to another communication channel. The new communication channel, which the communications are moved to, may be in the CBRS band or in a non-CBRS band. In embodiments, the new communication channel is provided by a different base station or different cell that provides an overlap in coverage to the UE. Communications are switched to the new communication channel before the base station or cell that serviced the CBRS band communication channel with the terminated grant is shut down.

Some embodiments move communication channels between base stations and cells that provide service coverage to a UE to form a first group and second group. The first group, or serviced group, includes base stations and cells with communication channels currently servicing (actively providing communications) to the UE and the second group or free group includes base stations and cells with associated communication channels that, although are able to communicate with the UE are currently in an idle state. In this example embodiment, when a termination of a grant to a serviced communication channel in the CBRS band group occurs, communications in the terminated serviced communication channel are switched over to a new communication channel serviced by a base station or cell and associated channel in the free group. Once termination has occurred, the base station in the serviced group may be reconfigured to the new communication channel and a distribution of the load of UEs across all base stations and cells providing service coverage areas to the UEs may occur. Although this system may lose some capacity, due to having at least one idle base station/cell and communication channel available for the free group to redirect communication signals through, the switching between channels is done without an interruption in service to the UE.

Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with the UEs Furthermore, it is also to be understood that 5G NR embodiments can be used in both standalone and non-standalone modes (or other modes developed in the future), and the following description is not intended to be limited to any particular mode. Moreover, the software and hardware used to implement the private radio access network is also generally referred to here as “entities” or “private radio access network entities.”

Generally base stations described herein relay information (communications) between the cellular service providers core network and UEs. Examples of base stations include, but are not limited to, a 5G NR base station (which may be referred to as a “gNodeB” or “gNB”) and a 4G LTE base station (which may be referred to as an evolved “NodeB”, “eNodeB” or eNB). A base station such as gNB may be implemented in a distributed manner in which each base station is partitioned into at least one central unit (CU), at least one distributed unit (DU), and one or more radio points. Generally, each CU implements Layer 3 and non-time critical Layer 2 functions for the associated base station. Each DU is typically configured to implement the time critical Layer 2 functions and at least some of the Layer 1 (also referred to as the Physical Layer) functions for the associated base station. A radio point (RP) of a base station may be configured to implement a radio frequency (RF) interface (transmit and receive) and the physical layer functions for the associated base station not implemented in the DU.

RPs or access points as described herein is a generic term for communication access points of a base station and cell that may include for example, Citizens Broadband Radio Service Device (CBSD) access points, 5G remote radio units (RRUs), 4G remote raid heads (RRHs), a 5G distribute antenna unit (DAS) remote antenna units (RAUs) and a 4G DAS RAU, etc.

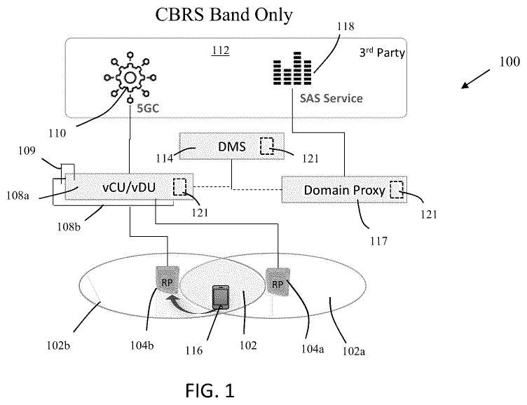

An example of a communication system 100 of a private radio access network with uninterrupted service in CBRS band is illustrated in FIG. 1. The communication system 100 uses CBRS and one or more wireless access protocols (such as 4G LTE and 5G NR) to provide wireless connectivity to one or more of the UEs 116. The communication system 100 in this example, includes a 5G core network 110 and SAS 118 that is part of a third part network 112. Further illustrates in this example is device management system (DMS) 114 and a domain proxy 117.

The DMS 114 is designed to deploy, configure, and monitor public radio access networks. The DMS 114 may be located at the edge or in other locations including in locations within a third-party network. The domain proxy 117 is in communication with the SAS 118. The domain proxy 117 is a logical function that can be an independent software or integrated with management systems. As an independent software, a domain proxy 117 can be deployed on premise or at edge or cloud location.

The communication system 100, in this example, includes two base stations. A first base station includes virtualized central unit/virtualized distributed unit (vCU/vDU) 108a and RP 104a and a second base station includes vCU/vDU 108b and RP 104b. The vCU/vDU 108a and the vCU/vDU 108b are in communication with the DMS 114 and the domain proxy 117.

The private radio network of the communication system 100 is configured to interact with the SAS 118 through the domain proxy 117 in this example, which in turn is configured to interact with an Environmental Sensing Capability (ESC) (not shown) and to dynamically manage access by a base station that includes a CBRS AP to the CBRS Spectrum in accordance with the relevant regulations and protocols promulgated for using the CBRS band. The SAS 118 may be deployed and managed by a third-party vendor in a respective cloud (not shown).

Embodiments take advantage of overlap coverage area 102 provided by coverage area 102a provided by a first base station and coverage area 102b provided by a second base station. The first base station in this example includes vCU/vDU 108a and RP 104a and the second base station in this example includes vCU/vDU 108b and RP 104b. In this example, UE 116 is within the overlap service coverage area 102 and hence can communicate with both the first and second base stations.

The example of FIG. 1 illustrates a communication system 100 that allows for switching between CBRS band channels. In this situation another channel in the CBRS band is available when a termination of grant to a serviced channel in the CBRS band is issued by the SAS 118. When the termination of grant is issued by the SAS 118, a channel moving function 121 that may be implemented by, for example, the domain proxy 117 or the DMS 114 or vCU/vDU 108a and 108b of a base station, switches communication signals from the terminated serviced communication channel provided by a first base station to another communication channel provided by the second base station.

In the example of FIG. 1, a first base station, that includes vCU/vDU 108a and RP 104a, provides service coverage area 102a. UE 116 is in communication with the first base station through a serviced CBRS band channel via service coverage area 102a. When the termination of the grant is issued by the SAS 118, communications with UE 116 is switched over to another channel in the CBRS band that is used by a second base station, which in this example, includes vCU/vDU 108b and RP 104b. The base stations which include vCU/vDU 108a and vCU/vDU 108b are in communication with each other via communication link 109 to affect a handover of the communications from the first base station to the second base station. The handover occurs before the first base station is taken down pursuant to the termination of the grant to the serviced CBRS band communication channel.

The SAS 118 may suggest an available CBRS Band communication channel to replace the terminated serviced communication channel, the channel moving function 121 may request an available CBRS Band communication channel or a free CBRS Band communication channel already assigned to the service network may be used to replace the terminated serviced communication channel with the second base station.

In an example, without of an available back-up grant, upon receiving notice of the termination of the grant, the channel moving function 121 provides a grant request for a new communication channel from the SAS 118. Once the new grant request is approved, a handover of the communications from the first base station using the service CBRS band communication channel to the second base station occurs before communication is terminated in the terminated serviced communication channel served by the first base station. After the termination is completed, the first base station may also be switched to the new communication channel. Hence, overlap service coverage area 102 for the UE 116 allows for switching of communications to the second base station servicing a second CBRS channel before the first base station goes off-line therein providing a seamless redirect of the communication signals.

In an example embodiment that includes free communication channels (backup communication channels), base stations and associated communication channels may be grouped into a serviced group and a free group. The serviced group includes base stations and associated serviced communication channels that are currently providing communications between the service providers core network and the UE 116. The free group include base stations and associate channels that although they could provide a communication link between the service providers core network and the UE 116, they are in an idle or backup state.

In an example, the first base station that includes vCU/vDU 108a and RP 104a, may be servicing the terminated serviced communication channel in the CBRS band and the second base station that includes vCU/vDU 108b and RP 104b may be servicing a free communication channel in the free group. The channel moving function 121 in this example, switches communications in the terminated serviced communication channel provided by the first base station to a back-up or free communication channel provided by the second base station before communications are terminated in the terminated serviced communication channel. Although, having one or more base stations in a free group, may limit some capacity, it ensures a seamless redirect of the communication signals

Although the embodiment of FIG. 1 is described as including two base stations there can be any number of base stations over one. For example, if there are a total of 10 base stations that provide overlap coverage, 5 base stations could be assigned to the servicing group and the remaining base stations could be assigned to the free group. When a CBRS band serviced communication channel grant termination is issued by the SAS 118, the base stations assigned to the serving group may be temporarily taken down for new assignment from the SAS 118 pursuant to the termination. In an embodiment, before the base stations in the serviced group are taken down, the channel moving function 121 activates the base stations in the idle group and redirects communications from the CBRS band serviced channels to the associated idle communication channels in the idle group. Although there could be a degradation in terms of capacity in a system, if back-up CBRS band communication grants are present, there will be no disruption of service to UE 116 with this system.

Further, in another example, a base station is configured to transmit multiple cells for a given telecommunication service provider. Each cell of the base station includes its own radio module which is referred herein as its own radio point. For example, in FIG. 1, RP 104a may be used to transmit/receive for a first cell and RP 104b may be used to transmit/receive for a second cell of the base station. In this example, instead of using a second base station, a communication channel in the second cell of the base station may be used to switch communications from a terminated CBRS band communication channel in the first cell.

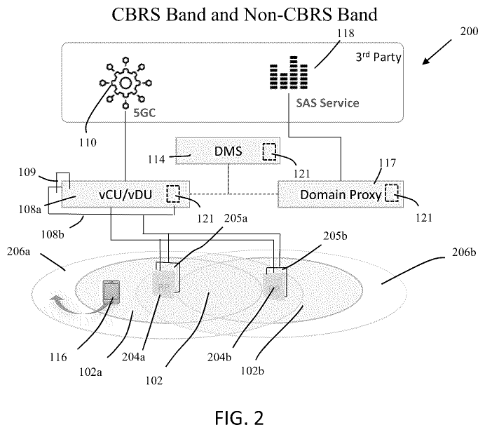

The simplified communication system 100 with uninterrupted service in the CBRS band of FIG. 1 is illustrated as being in communication with a 5G core network 110 to provide an additional 5G communication network service. In an example embodiment, a non-CBRS band, such as a 5G communication network service, is integrated into the simplified communication system 200 with uninterrupted service in the CBRS band as illustrate in FIG. 2. An example of an application where a wireless communication service provider may use this configuration is in an indoor coverage area to augment a licensed band with a CBRS band to add capacity.

In the communication system 200 example of FIG. 2, a first base station that includes vCU/vDU 108a and RPs 204a and 204b provides CBRS band service coverage areas 102a and 102b. A second base station that includes vCU/vDU 108b and RPs 205a and 205b provides service coverage areas 206a and 206b. In this example, the UE 116 is within an overlap service coverage area provided by service coverage area 102a and service coverage area 206a. RP 204a may be co-located with RP 205a and RP 204b may be co-located with RP 205b in this example. Further, in this example, RPs 204a and 204b are CBRS APs and RPs 205a and 205b are 5G RUs.

In this example, the first base station provides CBRS band channel communications, and the second base station provides non-CBRS band channel communications (5G communication channels in this example). If the SAS 118 terminates the grant to one or more of the CBRS band communication channels serviced by the first base station, the communication signals in the terminated serviced CBRS band communication channels are redirected to one or more non-CBRS Band channels in the free group serviced by the second base station before the serviced communication channels are terminated. As discussed above, handover procedures are communicated between the base stations through communication link 109.

When grants once again become available in the CBRS band, communications that were switched to the non-CBRS band channels may be re-directed back into the CBRS band channels serviced by the first base station. With any communication channel change between bands in embodiments, the communication sessions at the UE 116 continue seamlessly. The handovers between CBRS band channels and the non-CBRS band (licensed channels, such as 5G physical cell ID(PCI) channels and LTE PCI channels) may be accomplished through base station communication link 109 using standard 3GPP protocol procedures.

Here again, in an embodiment that includes a base station with multiple cells, RP 204a and 204b may transmit/receive for a first cell and RP 205a and 205b may be used to transmit/receive for a second cell of the base station. In one example, instead of using a second base station the second cell of the base station is used to provide a communication channel to continue communications with the UE when CBRS band channel is terminated. Further in an example that includes both a second base station and at least one of the first and second base stations include multiple cells, communications with the UE 116 may be moved between the base stations and cells to create a free group that may include a base station and/or cell that are idle with idle communication channels even though they provide service coverage and a serviced group that includes a base station and/or cell currently providing communications to the UE.

As discussed above, the procurement of a secondary communication channel (a free communication channel from the free group) can happen at two points of time. The first time uses a reactive approach when certain events occur, such as when a termination of a grant occurs. In an example, the SAS 118 provides a time stamp on a termination of grant. The system will have a few seconds from the time stamp to select a new free channel and cease communicating to the old communication channel (bring down the base station or the cell) in the reactive approach. In another example, a proactive approach is used. With the proactive (or back-up grant) approach, at least one additional grant is kept open such that an N+1 option is available when it is needed. The downfall to this approach is that it will cost more to pay for a grant. However, this approach may be a viable option in system where channels are moved frequently.

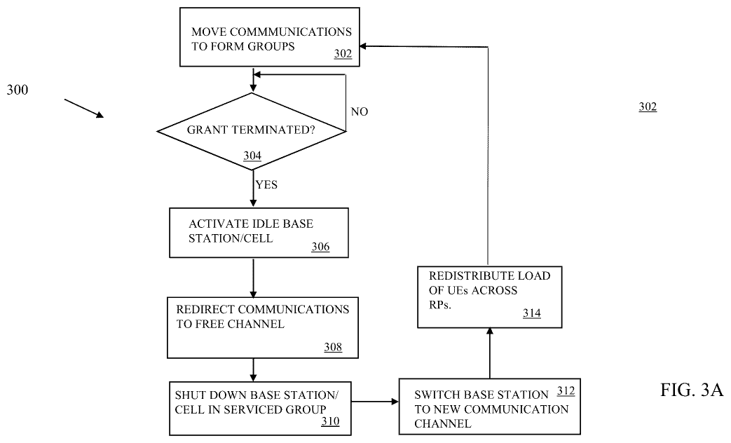

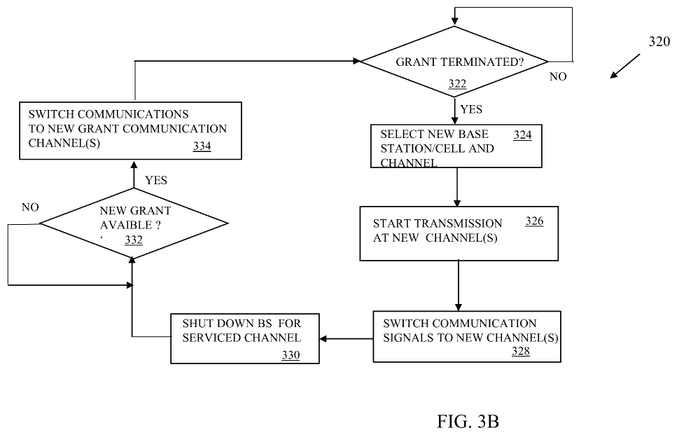

FIGS. 3A and 3B comprise high-level flow diagrams 300 and 320 illustrating exemplary embodiments of methods of enabling the switch of communications between a CBRS band channel and another communication channel upon request of a SAS. The flow diagrams 300 and 320 shown in FIGS. 3A and 3B are described here as being implemented using the channel switching function described above in connection with FIGS. 1 and 2. More specifically, the processing of methods shown the flow diagrams 300 and 320 are described here as primarily being implemented using one of DMS 121, CU, DU (such as vCU/vDU 108a and 108b) or domain proxy 117, implementing the channel switching function. However, it is to be understood that other embodiments can be implemented in other ways and the channel switching function may be implemented in other systems.

The blocks of the flow diagrams 300 and 320 shown in FIGS. 3A and 3B have been arranged in a generally sequential manner for ease of explanation; however, it is to be understood that this arrangement is merely exemplary, and it should be recognized that the processing associated with the methods (and the blocks shown in FIGS. 3A and 3B) can occur in a different order (for example, where at least some of the processing associated with the blocks is performed in parallel and/or in an event-driven manner). Hence, embodiments are not limited to sequence of block as set out in FIGS. 3A and 3B.

FIG. 3A illustrates a flow diagram example that uses backup grants to switch communications to when a serviced communication channel grant is terminated. Flow diagram 300 starts at block 302 where communications are moved between base stations and/or cells to create a serviced group and a free group. The serviced group includes base stations and cells with communication channels that are currently being used to communicate with a UE. The free group includes base stations and cells that although they provide service coverage with the UE they are currently not communicating with the UE. The communication channels in the free group are idle in an example. The communication channels in the free group may include other CBRS band communication channels as well as non-CBRS band communication channels.

Communication may continue with the use of a CBRS band communication channel until a grant to the communication channel is terminated at block 304. When a grant is terminated, one or more select idle base stations/cells in the free group with inactive communication channels are activated at block 306. Communications are then redirected to free communications channels serviced by the now activated base stations/cells at block 308. The base stations/cells that were using the serviced communication channels that were terminated are briefly shutdown at block 310 after the handover of the communications to the free communication channels to accomplish the termination of the grant.

Further in an example, the base stations/cells that were shut down due to the termination of the grant may be switched over to the free communication channels that are currently providing communication between the communication system and the UE after the termination process is complete at block 312. In one example, the channel switching function further redistributes a load of the UEs 116 across all RPs of the base stations/cells providing service coverage and the process continues at block 314.

The flow diagram 320 of FIG. 3B illustrates an example where backup communication channels are not used. As illustrated, this process starts at block 322 where request from the SAS is monitored. If no request is detected, the process continues at block 322. If a termination of grant to a serviced CBRS band communication channel is issued by the SAS at block 322, a new base station/cell and associated communication channel is selected at block 324. The new communication channel may be suggested by the SAS or requested if other CBRS band communication channels are available. Further in a communication system that is capable of communication with other non-CBRS band communication channels, other base stations/cells and non-CBRS band communication channels may be selected as the new communication link to the UE 116.

Once the new communication channel and associated base station/cell is selected, transmissions through the base station/cell and communication channel are started at block 326. The communications in the serviced communication channel are then switched over the new communication channel and associated base station at block 328 using a handover protocol. The base station that serviced the serviced CBRS communication channel with the terminate grant, is then shut down to effectuate the termination at block 330.

Further in an example, it is monitored at block 332 if a new grant to a communication channel in the CBRS band is available. If a new grant becomes available, communications may be switched to the new grant communication channel(s) in the CBRS band at block 334. The process then continues at block 322. An example when flow diagram 320 of FIG. 3B may be used is when an initial grant to communications in the CBRS band is terminated and the communications are switch over to a non-CBRS band serviced by a non-CBRS base station for a period of time until a new grant in the CBRS band is issued.

### Example Embodiments

Example 1 is a communication system with uninterrupted service in citizens broadband radio service (CBRS) band. The communication system includes a first base station and a channel moving function. The first base station is in communication with at least one core network of a wireless communication service provider. The first base station is further in communication with a spectrum access system (SAS) that allocates communication channels in the CBRS band. The first base station uses the CBRS band to communicate with user equipment (UE). The first base station also includes at least one radio point (RP) to transmit and receive wireless communication signals. The first base station provides a first service coverage area for the UE that establishes a communication link with the UE using a first CBRS band communication channel. The channel moving function is configured to redirect communications from the first CBRS band communication channel when a termination of grant to the first CBRS communication channel is issued by the SAS to a second communication channel serviced by a second base station that provides a second service coverage area for the UE through at least a second RP before the first CBRS communication channel is terminated.

Example 2 includes the communication system of Example 1, wherein the at least one first RP is one of a CBRS access point (AP), a 5G remote radio unit (RRU), a 4G remote radio head (RRH), a 5G distribute antenna unit (DAS) remote antenna unit (RAU), a 4G DAS RAU, and the at least one second RP is one of a CBRS AP, a 5G RRU, a 4G RRH, 5G DAS RAU, and a 4G DAS RAU.

Example 3 includes the communication system of any of the Example 1-2, wherein the channel moving function is further configured to move communications with the UE to create a free group of base stations that provide service coverage with the UE but have idle communication channels and an active group that includes base stations that are currently providing communications with the UE through active communication channels, the second communication channel selected from the idle communication channels in the free group.

Example 4 includes the communication system of and of the Examples 1-3, wherein the second communication channel is one of a CBRS band communication channel and a non-CBRS band communication channel.

Example 5 includes the communication system of any of the Examples 1-4, wherein at least one of the first and second base stations are one of a 5G NR base station and a 4G LTE base station.

Example 6 includes the communication system of any of the Examples 1-5, wherein channel moving function is implemented by one of a central unit (CU), a distribute unit (DU), and a device management system (DMS).

Example 7 includes the communication system of Example 6, wherein at least one of the CU, DU and DMS are part of one of the first and second base stations.

Example 8 includes the communication system of any of the Examples 1-9, wherein the UE is one of a plurality of UEs. The channel moving function is further configured to redistribute a load of UEs across RPs of the first and second base stations.

Example 9 includes a communication system with uninterrupted service in citizens broadband radio service (CBRS) band. The communication system includes at least one base station and a channel moving function. The at least one base station is in communication with at least one core network of a wireless communication service provider. The at least one base station is in communication with a spectrum access system (SAS) that allocates communication channels in the CBRS band. The at least one base station uses the CBRS band to communicate with user equipment (UE). The at least one base station includes at least a first radio point (RP) and a second RP to transmit and receive wireless communication signals through a first and second cell. The at least one base station provides a service coverage area for the UE with the first RP to establishes a communication link with the UE using a first CBRS band communication channel in the first cell. The channel moving function is configured to redirect communications from the first CBRS band communication channel when a termination of grant to the first CBRS communication channel is issued by the SAS to a second communication channel serviced by the second RP of the second cell that provides a second service coverage area for the UE before the first CBRS communication channel is terminated.

Example 10 includes the communication system of Example 10, wherein the second communication channel is one of a CBRS band communication channel and a non-CBRS band communication channel.

Example 11 includes a method of operating a communication system using a citizens broadband radio service (CBRS) band. The method includes using a first CBRS band communication channel provided by a first base station for communications with user equipment (UE) within a first service coverage area of the first base station; and upon receiving a notice of termination of the first CBRS band communication channel, switching communications from the first CBRS band communication channel to a second communication channel provided by one of a second base station and a cell of the first base station before the first CBRS band communication channel is terminated.

Example 12 includes the method Example 11, further including moving communications with the UE to create a free group of at least one of base stations and cells that provide service coverage with the UE but have idle communication channels and an active group of at least one of base stations and cells that are currently providing communications with the UE through active communication channels, the second communication channel selected from the idle communication channels in the free group.

Example 13 includes the method Example 12, further including configuring the first base station to communicate through the second communication channel after the first CBRS band communication channel is terminated.

Example 14 includes the method of any Examples 11-13, further including switching communications back to the CBRS band communication channel when a CBRS band communication channel becomes available.

Example 15 includes the method of any of the Examples 11-14, further wherein the second communication channel is one of a CBRS band communication channel and a non-CBRS band communication channel.

Example 16 includes the method any of the Examples 11-15, further including redistributing a load of all UEs within service coverage areas across all base station radio points after switching communications from the first CBRS band communication channel to the second communication channel.

Example 17 includes a method of operating a communication system using a citizens broadband radio service (CBRS) band. The method includes using a CBRS band communication channel for communications with a first base station and user equipment (UE) through a CBRS access point of the first base station; and upon receiving a notice of termination of the CBRS band communication channel, switching communications from the CBRS band communication channel to a non-CBRS band communication channel provided by one of a second base station and a cell before the CBRS band communication channel is terminated, wherein the UE is within a service coverage area of the one of the second base station and the cell.

Example 18 includes the method of Example 17, wherein the one of the second base station and cell uses a radio point that is one of a CBRS access point (AP), a 5G remote radio unit (RRU), a 4G remote radio head (RRH), a 5G distribute antenna unit (DAS) remote antenna unit (RAU), and a 4G DAS RAU to communicate with the UE.

Example 19 includes the method of any of the Examples 17-18, further including switching communications back to a CBRS band communication channel once another CBRS band communication channel become available.

Example 20 includes the method of any of the Examples 17-19, further including implementing handover procedures communicated between the first base station and the one of the second base station and the cell in switching communications from the CBRS band communication channel to the non-CBRS band communication channel before the CBRS band communication channel is terminated.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A communication system with uninterrupted service in citizens broadband radio service (CBRS) band, the communication system comprising:
a first base station in communication with at least one core network of a wireless communication service provider, the first base station in communication with a spectrum access system (SAS) that allocates communication channels in the CBRS band, the first base station using the CBRS band to communicate with user equipment (UE);
the first base station including at least one radio point (RP) to transmit and receive wireless communication signals, the first base station providing a first service coverage area for the UE that establishes a communication link with the UE using a first CBRS band communication channel; and
a channel moving function configured to redirect communications from the first CBRS band communication channel when a termination of grant to the first CBRS communication channel is issued by the SAS to a second communication channel serviced by a second base station that provides a second service coverage area for the UE through at least a second RP before the first CBRS communication channel is terminated.

2. The communication system of claim 1, wherein the at least one first RP is one of a CBRS access point (AP), a 5G remote radio unit (RRU), a 4G remote radio head (RRH), a 5G distribute antenna unit (DAS) remote antenna unit (RAU), a 4G DAS RAU, and the at least one second RP is one of a CBRS AP, a 5G RRU, a 4G RRH, 5G DAS RAU, and a 4G DAS RAU.

3. The communication system of claim 1, wherein the channel moving function is further configured to move communications with the UE to create a free group of base stations that provide service coverage with the UE but have idle communication channels and an active group that includes base stations that are currently providing communications with the UE through active communication channels, the second communication channel selected from the idle communication channels in the free group.

4. The communication system of claim 1, wherein the second communication channel is one of a CBRS band communication channel and a non-CBRS band communication channel.

5. The communication system of claim 1, wherein at least one of the first and second base stations are one of a 5G NR base station and a 4G LTE base station.

6. The communication system of claim 1, wherein channel moving function is implemented by one of a central unit (CU), a distribute unit (DU), and a device management system (DMS).

7. The communication system of claim 6, wherein at least one of the CU, DU and DMS are part of one of the first and second base stations.

8. The communication system of claim 1, wherein the UE is one of a plurality of UEs, the channel moving function further configured to redistribute a load of UEs across RPs of the first and second base stations.

9. A communication system with uninterrupted service in citizens broadband radio service (CBRS) band, the communication system comprising:
at least one base station in communication with at least one core network of a wireless communication service provider, the at least one base station in communication with a spectrum access system (SAS) that allocates communication channels in the CBRS band, the at least one base station using the CBRS band to communicate with user equipment (UE);
the at least one base station including at least a first radio point (RP) and a second RP to transmit and receive wireless communication signals through a first and second cell, the at least one base station providing a service coverage area for the UE with the first RP to establishes a communication link with the UE using a first CBRS band communication channel in the first cell; and
a channel moving function configured to redirect communications from the first CBRS band communication channel when a termination of grant to the first CBRS communication channel is issued by the SAS to a second communication channel serviced by the second RP of the second cell that provides a second service coverage area for the UE before the first CBRS communication channel is terminated.

10. The communication system of claim 9, wherein the second communication channel is one of a CBRS band communication channel and a non-CBRS band communication channel.

11. A method of operating a communication system using a citizens broadband radio service (CBRS) band, the method comprising:
using a first CBRS band communication channel provided by a first base station for communications with user equipment (UE) within a first service coverage area of the first base station; and
upon receiving a notice of termination of the first CBRS band communication channel, switching communications from the first CBRS band communication channel to a second communication channel provided by one of a second base station and a cell of the first base station before the first CBRS band communication channel is terminated.

12. The method of claim 11, further comprising:
moving communications between with the UE and radio points (RPs) to create a free group that includes at least one RP that provides service coverage to the UE but has at least one idle communication channel and an active group that includes at least one RP that is currently providing service coverage through at least one active communication channel, wherein the RPs are part of one of base stations and cells of a base station, the second communication channel selected from the free group.

13. The method of claim 12, further comprising:
configuring the first base station to communicate through the second communication channel after the first CBRS band communication channel is terminated.

14. The method of claim 11, further comprising:
switching communications back to a CBRS band communication channel when a CBRS band communication channel becomes available.

15. The method of claim 11, wherein the second communication channel is one of a CBRS band communication channel and a non-CBRS band communication channel.

16. The method of claim 11, further comprising:
redistributing a load of all UEs within service coverage areas across all base station radio points after switching communications from the first CBRS band communication channel to the second communication channel.

17. A method of operating a communication system using a citizens broadband radio service (CBRS) band, the method comprising:
using a CBRS band communication channel for communications with a first base station and user equipment (UE) through a CBRS access point of the first base station; and
upon receiving a notice of termination of the CBRS band communication channel, switching communications from the CBRS band communication channel to a non-CBRS band communication channel provided by one of a second base station and a cell before the CBRS band communication channel is terminated, wherein the UE is within a service coverage area of the one of the second base station and the cell.

18. The method of claim 17, wherein the one of the second base station and cell uses a radio point that is one of a CBRS access point (AP), a 5G remote radio unit (RRU), a 4G remote radio head (RRH), a 5G distribute antenna unit (DAS) remote antenna unit (RAU), and a 4G DAS RAU to communicate with the UE.

19. The method of claim 17, further comprising:
switching communications back to a CBRS band communication channel once another CBRS band communication channel become available.

20. The method of claim 17, further comprising:
implementing handover procedures communicated between the first base station and the one of the second base station and the cell in switching communications from the CBRS band communication channel to the non-CBRS band communication channel before the CBRS band communication channel is terminated.
